(19) United States
(12) Patent Application Publication
(10) Pub. No.: US 2011/0176699 A1
(43) Pub. Date: Jul. 21, 2011

(54) EARPHONE WITH A FIXED FUNCTION AND EARPLUG WITH A FIXED FUNCTION

(76) Inventor: PI-FEN LIN, Keelung City (TW)

(21) Appl. No.: 12/691,446

(22) Filed: Jan. 21, 2010

(51) Int. Cl. H04R 25/00

(52) U.S. Cl. 381/374

(57) ABSTRACT

An earphone with a fixed function includes an earphone housing having a holding portion and an earplug sleeved around the holding portion. The earplug has a sleeved portion, a fixed portion and an abutting portion. The fixed portion extended from a periphery of the sleeved portion has a bent portion and a jamming portion. One end of the bent portion is fixed on the sleeved portion and the other end of the bent portion is bent and extended to form the jamming portion.

### BACKGROUND OF THE INVENTION

1. Field of the Invention

The present invention relates to an earphone and an earplug, in particular, to the earphone with a fixed function and the earplug with a fixed function.

2. Description of Related Art

With the rapid development of portable multimedia devices or stereo equipments, earphones such as traditional earphones or Bluetooth earphones have been widely used.

Referring to FIG. 1, a traditional earbud-type earphone includes an earphone housing 1a and an earplug 2a. The earphone housing 1a has a speaker 11a correspond to user's ear canal and the earplug 2a is sleeved around the speaker 11a. The earplug 2a and the speaker 11a are inserted into the user's ear canal and the user can listen to the audio sound produced by the speaker 11a.

However, the speaker 11a sleeved with the earplug 2a must be inserted into the user's ear canal for listening. The size of the earplug 2a usually not mates with the size of the user's ear canal. If the earplug 2a is too large, the user will feel uncomfortable. If the earplug 2a is too small, the speaker 11a will be too loose in the user's ear canal such that the earphone housing 1a is easy to dislodge from the user's ear.

### SUMMARY OF THE INVENTION

In view of the aforementioned issues, the present invention provides an earphone with a fixed function. The earphone can mate with a pinna of user's ear, so as to the earphone can comfortably and stably secure to the pinna of the user's ear and can increase stereo of a speaker.

To achieve the above-mentioned objectives, the present invention provides an earphone with a fixed function including an earphone housing having a holding portion and an earplug sleeved around the holding portion. The earplug has a sleeved portion, a fixed portion and an abutting portion. The fixed portion extended from a periphery of the sleeved portion has a bent portion and a jamming portion. One end of the bent portion is fixed on the sleeved portion and the other end of the bent portion is bent and extended to form the jamming portion.

Therefore, the sealed portion and the fixed portion can be properly deformed according to the profile of the pinna of user's ear. The earphone housing can be comfortably secured to the user's ear without putting the earplug into the ear canal, so as to avoid a tingle and a bacterial infection in the user's ear.

Moreover, the sealed portion fits the pinna outside the ear canal and the fixed portion jams the upper cartilage and the lower cartilage of the pinna of the user's ear, so as to constitute a function of supporting and fixing for making the holding portion not be too loose in the user's ear such that the earplug will not dislodge from user's ear.

Further, the holding portion is inserted into the sleeved hole and be positioned in the sealed space such that the sealed portion encircles the holding portion for increasing stereo.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are provided solely for reference and illustration, without any intention that they be used for limiting the present invention.

### BRIEF DESCRIPTION OF THE DRAWINGS

FIG. 1 is a schematic view of the traditional earphone according to the prior art;

FIG. 2A is a exploded view of earphone with a fixed function of the present invention;

FIG. 2B is another exploded view of earphone with a fixed function of the present invention;

FIG. 3 is a assembled view of earphone with a fixed function of the present invention;

FIG. 4 is a cross-sectional view of earphone with a fixed function of the present invention;

FIG. 5A is a top view of the fixed portion of the earphone with a fixed function according to the first embodiment of the present invention;

FIG. 5B is a top view of the fixed portion of the earphone with a fixed function according to the second embodiment of the present invention;

FIG. 5C is a top view of the fixed portion of the earphone with a fixed function according to the third embodiment of the present invention;

FIG. 5D is a top view of the fixed portion of the earphone with a fixed function according to the fourth embodiment of the present invention;

FIG. 5E is a top view of the fixed portion of the earphone with a fixed function according to the fifth embodiment of the present invention;

FIG. 5F is a top view of the fixed portion of the earphone with a fixed function according to the sixth embodiment of the present invention;

FIG. 5G is a top view of the fixed portion of the earphone with a fixed function according to the seventh embodiment of the present invention;

FIG. 6 is a using-state view of earphone with a fixed function of the present invention;

FIG. 7A is a top view of the earphone housing of the earphone with a fixed function according to the eighth embodiment of the present invention;

FIG. 7B is a top view of the earphone housing of the earphone with a fixed function according to the ninth embodiment of the present invention; and

FIG. 7C is a top view of the earphone housing of the earphone with a fixed function according to the tenth embodiment of the present invention.

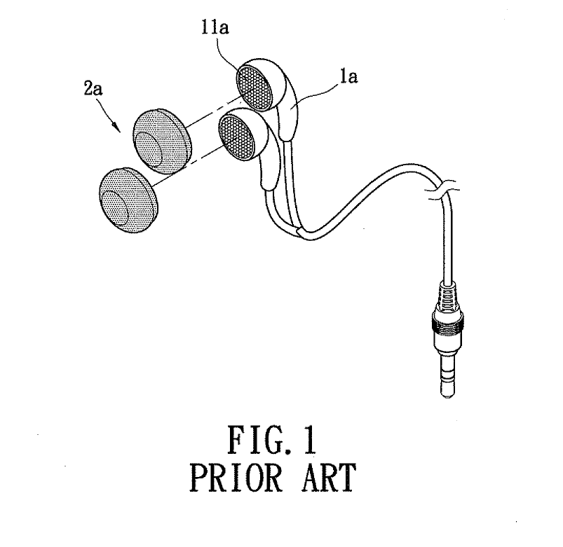

### DETAILED DESCRIPTION OF THE PREFERRED EMBODIMENTS

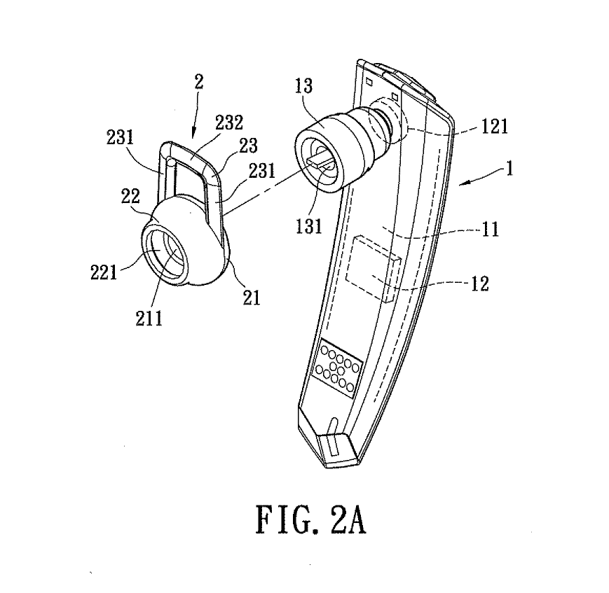

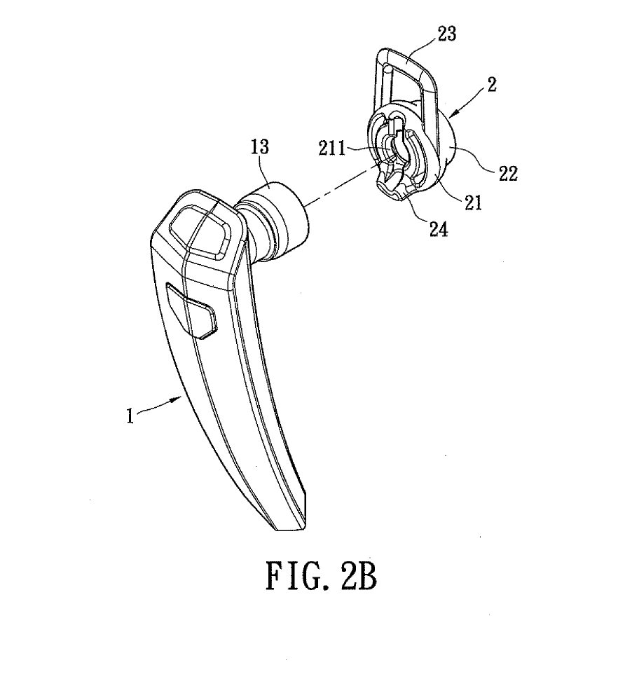

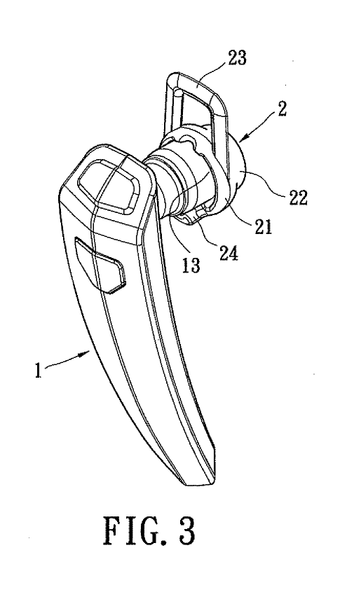

Referring to FIGS. 2A, 2B, and 3, the first embodiment of the present invention provides an earphone with a fixed function including an earphone housing 1 and an earplug 2.

The earphone housing 1 has an accommodating space 11, a signal receiver 12, and a holding portion 13. The accommodating space 11 is disposed within the earphone housing 1 for receiving the signal receiver 12 having a speaker 121. The holding portion 13 has a sound passageway 131 which is connected with the accommodating space 11. The signal receiver 12 can pick up electrical signals which are generated from players, computers, mobile phones, telephones or other electronic products via transmission line, Bluetooth, infrared, or other wired or wireless signal transmitter. The signal receiver 12 can translate electronic signals to audible sound and transmit the same to the speaker 121 such that the audible sound passes through the sound passageway 131. However, the signal receiver 12 is a commonly known electronic component and does not rehearse it here.

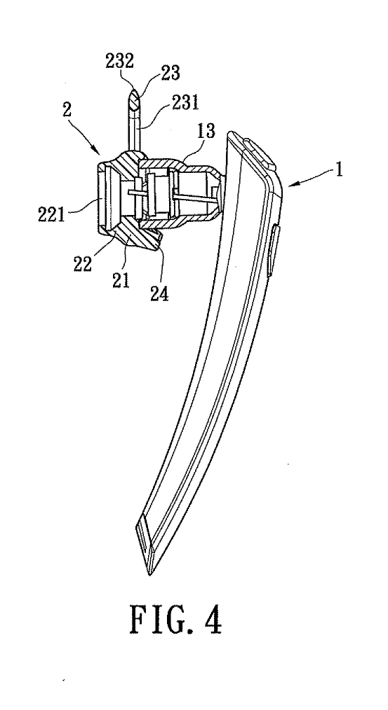

The earplug 2 has a sleeved portion 21, a sealed portion 22, a fixed portion 23 and an abutting portion 24. The sealed portion 22 is extended from a face of the sleeved portion 21. The fixed portion 23 is extended from a periphery of the sleeved portion 21. The abutting portion 24 is disposed with another face of the sleeved portion 21. The sleeved portion 21 has a sleeved hole 211 penetrated through the sleeved portion 21. When the sleeved portion 21 sleeves around the holding portion 13 of the earphone housing 1, the holding portion 13 is inserted into the sleeved hole 211 such that the sleeved portion 21 presses holding portion 13 for achieving a fixed effect. The sealed portion 22 protrudes from a surface of the sleeved portion 21 and has a sealed space 221 connected with the sleeved hole 211. The holding portion 13 be inserted into the sleeved hole 211 and be positioned in the sealed space 221 (as shown in FIG. 4) so that the sealed portion 22 encircles the holding portion 13 for increasing stereo. The fixed portion 23 has a bent portion 231 and a jamming portion 232. One end of the bent portion 231 is fixed on the sleeved portion 21, and the other end of the bent portion 231 is bent and extended to form the jamming portion 232.

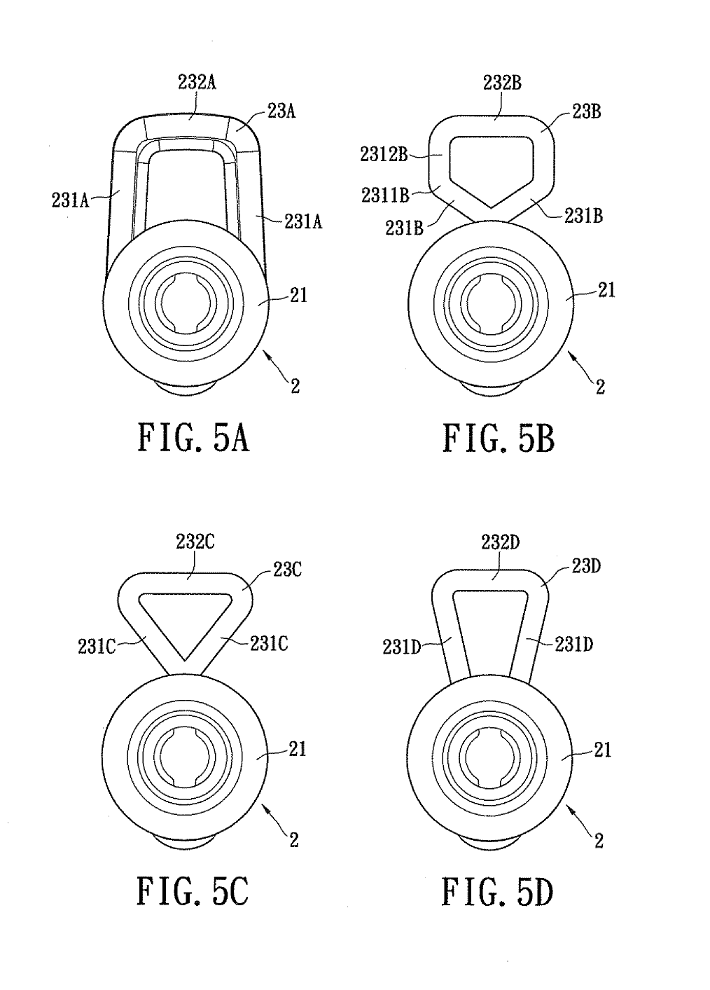

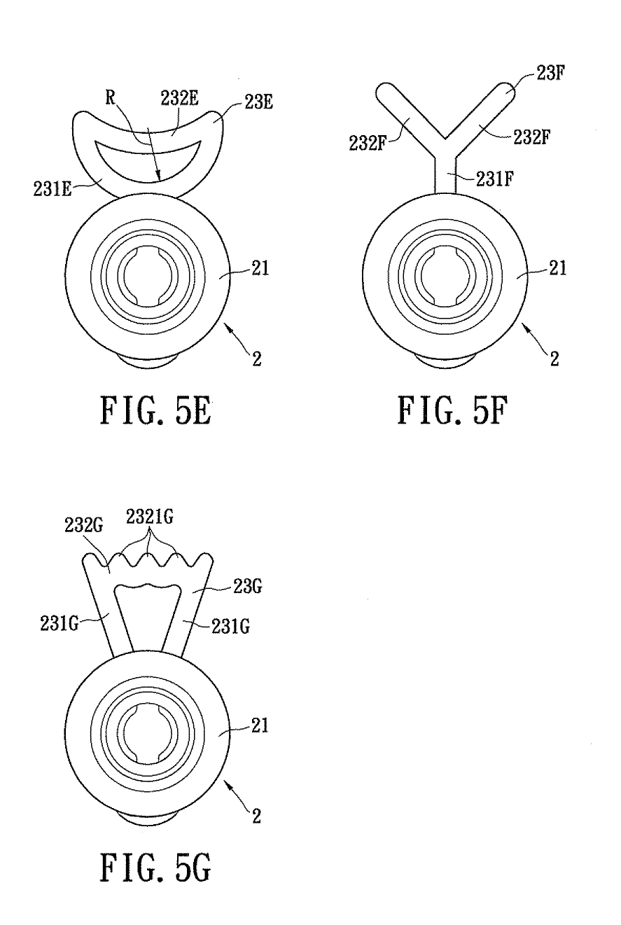

Referring to FIG. 5A, the first embodiment of the present invention. The fixed portion 23A has two bent portions 231A. One ends of the bent portions 231A are fixed on the sleeved portion 21 and are parallelly spaced at an interval. The other ends of the bent portions 231A are respectively connected with two ends of the jamming portion 232A. The two bent portions 231A and the jamming portion 232A constitute a rectangular geometry profile. Further, the fixed portion 23A may have different designs shown in FIGS. 5B to 5G.

Referring to FIG. 5B, the second embodiment of the present invention. The fixed portion 23B has two bent portions 231B. Each bent portion 231B has a first arm 2311B and a second arm 2312B. One end of the first arm 2311B is fixed on the sleeved portion 21, and is outwardly and slantly extended to form the other end of the first arm 2311B. One end of the second arm 2312B is connected with the other end of the first arm 2311B and is inwardly and slantly extended to form the other end of the second arm 2312B. The other ends of the second arms 2312B of the two bent portions 231B are respectively connected with two ends of jamming portion 232B. The two bent portions 231B and the jamming portion 232B constitute a pentagonal or above polygon geometry profile.

Referring to FIG. 5C, the third embodiment of the present invention. The fixed portion 23C has two bent portions 231C. One ends of the bent portions 231C converge at a point of the sleeved portion 21, and extend radially from the point to form the other ends of the bent portions 231C which are respectively connected with two ends of jamming portion 232C. The two bent portions 231C and the jamming portion 232C constitute a triangle geometry profile.

Referring to FIG. 5D, the fourth embodiment of the present invention. The fixed portion 23D has two bent portions 231D. One ends of the bent portions 231D are fixed on the sleeved portion 21 and spaced at an interval. The other ends of the two bent portions 231D are slantly extended along opposite direction to each other and are respectively connected with two ends of the jamming portion 232D. The two bent portions 231D and the jamming portion 232D constitute a ladder geometry profile.

Referring to FIG. 5E, the fifth embodiment of the present invention. The fixed portion 23E has a bent portion 231E with a radius of curvature R. A middle portion of the bent portion 231E is fixed on the sleeved portion 21 and is outwardly bent to form two ends of the bent portion 231E which are respectively connected with two ends of the jamming portion 232E. The bent portion 231E and the jamming portion 232E constitute a half-moon geometry profile.

Referring to FIG. 5F, the sixth embodiment of the present invention. The fixed portion 23F has a bent portion 231F and two jamming portions 232F. One end of the bent portion 231F is fixed on the sleeved portion 21 and the other end of the bent portion 231F is connected with one ends of the two jamming portions 232F.

Referring to FIG. 5G, the seventh embodiment of the present invention. The fixed portion 23G has two bent portions 231G and a jamming portion 232G with a plurality of ratchets 2321G. One ends of the bent portions 231G are fixed on the sleeved portion 21 and spaced at an interval. The other ends of the two bent portions 231G are respectively connected with two ends of the jamming portion 2320. The ratchets 2321G are continuous wave-like and are disposed between the two bent portions 231G.

Otherwise, a middle portion of the fixed portion 23, 23A, 23B, 23C, 23D, 23E, 23F, 23G can be solid body for achieving the same effect.

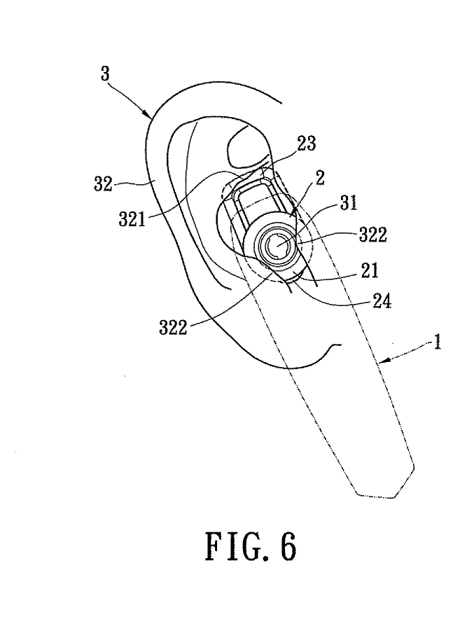

Referring to FIG. 6, when the earplug 2 is secured to the user's ear 3, the sealed portion 22 can be properly deformed correspond to the profile of the pinna 32 outside the ear canal 31 and can be close connect with the pinna 32 for increasing fitness and comfort of contacting. Otherwise, the sealed space 221 and the ear canal 31 encircle a sealed space without gaps between the sealed space 221 and the ear canal 31, so as to increase stereo of speaker 121.

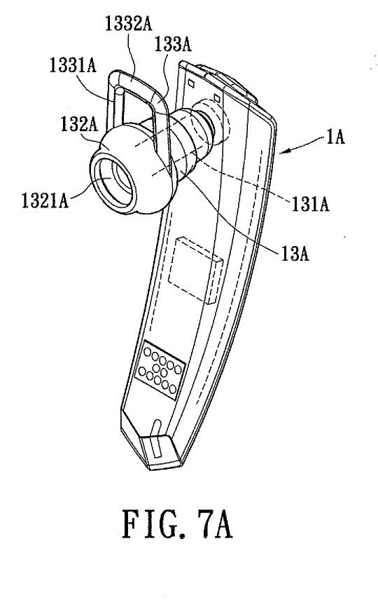

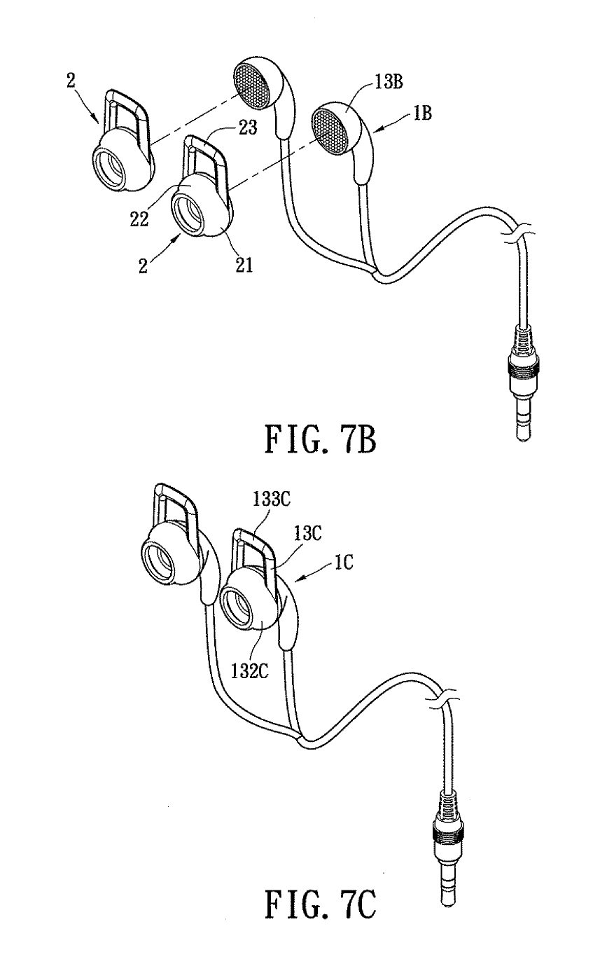

When the sealed portion 22 fits the pinna 32, the bent portions 231 of the fixed portion 23 can be properly deformed correspond to the profile of the pinna 32. The jamming portion 232 of the fixed portion 23 jams a upper cartilage 321 of the pinna 32 due to a elastic force produced by the deformed bent portions 231 and the abutting portion 24 abuts a lower cartilage 322 of the pinna 32 for supporting and fixing, so as to make the holding portion 13 not be too loose in the user's ear 3 such that the earplug 2 will not dislodge from user's ear 3. Further, the earphone housing 1 has different designs shown in FIGS. 7A to 7C.

Referring to FIG. 7A, the eighth embodiment of the present invention. The sealed portion 132A and the fixed portion 133A are integrally joined with the holding portion 13A of the earphone housing 1A. The earphone housing 1A disposes a holding portion 13A having a sound passageway 131A, a sealed portion 132A, and a fixed portion 133A. The sealed portion 132A is extended from a face of the holding portion 13A. The fixed portion 133A is extended from a periphery of the holding portion 13A. The sealed portion 132A disposes a sealed space 1321A connected with the sound passageway 131A. The fixed portion 133A has a bent portion 1331A and a jamming portion 1332A. One end of the bent portion 1331A is fixed on holding portion 13A, and the other end of the bent portion 1331A is bent and extended to faun the jamming portion 1332A.

Referring to FIG. 7B, the ninth embodiment of the present invention. One end of the earphone housing 1B is extended to form a holding portion 13B correspond to the user's ear canal.

Referring to FIG. 7C, the tenth embodiment of the present invention. One end of earphone housing 1C is extended to form a holding portion 13C correspond to the user's ear canal. The holding portion 13C has a sealed portion 132C and a fixed portion 133C. The sealed portion 132C is extended from a face of the holding portion 13C. The fixed portion 133C is extended from a periphery of the holding portion 13C. The sealed portion 132C and the fixed portion 133C are integrally joined with the holding portion 13C of the earphone housing 1C.

In conclusion, the present invention has following advantages:
1. The sealed portion 22 and the fixed portion 23 can be properly deformed according to the profile of the pinna 32. The earphone housing 1 can be comfortably secured to the user's ear without putting the earplug 2 into the ear canal 31, so as to avoid a tingle and a bacterial infection in the user's ear.
2. The sealed portion 22 fits the pinna 32 outside the ear canal 31 and the fixed portion 23 jams the upper cartilage 321 and the lower cartilage 322 of the pinna 32, so as to constitute a structure of supporting and fixing for making the holding portion 13 not be too loose in the user's ear 3 such that the earplug 2 will not dislodge from user's ear 3.
3. the holding portion 13 is inserted into the sleeved hole 211 and be positioned in the sealed space 221 such that the sealed portion 22 encircles the holding portion 13 for increasing stereo.

The above-mentioned descriptions merely represent solely the preferred embodiments of the present invention, without any intention or ability to limit the scope of the present invention which is fully described only within the following claims. Various equivalent changes, alterations or modifications based on the claims of present invention are all, consequently, viewed as being embraced by the scope of the present invention.

What is claimed is:

1. An earphone with a fixed function, comprising:
an earphone housing having a holding portion; and
an earplug having a sleeved portion and a fixed portion, wherein the sleeved portion sleeves around the holding portion of the earphone housing, and the fixed portion is extended from the sleeved portion, the sleeved portion having a bent portion and a jamming portion, the bent portion bent and extended to form the jamming portion.

2. The earphone according to claim 1, wherein the earplug further comprises a sealed portion extended from a face of the sleeved portion and having a sealed space, the holding portion inserted into the sleeved portion and positioned in the sealed space.

3. The earphone according to claim 2, wherein the earplug further comprises an abutting portion disposed with the sleeved portion.

4. The earphone according to claim 1, wherein the fixed portion further comprises another one bent portion, one ends of the bent portions fixed on the sleeved portion and parallelly spaced at an interval to each other, the other ends of the bent portions respectively connected with two ends of the jamming portion.

5. The earphone according to claim 1, wherein the fixed portion further comprises another one bent portion, each bent portion having a first arm and a second arm, one end of the first arm fixed on the sleeved portion and outwardly and slantly extended to form the other end of the first arm, one end of the second arm connected with the other end of the first arm and inwardly and slantly extended to form the other end of the second arm respectively connected with two ends of jamming portion.

6. The earphone according to claim 1, wherein the fixed portion further comprises another one bent portion, one ends of bent portions converging at a point of the sleeved portion and extended radially from the point to form the other ends of bent portions respectively connected with two ends of jamming portion.

7. The earphone according to claim 1, wherein the fixed portion further comprises another one bent portion, one ends of bent portions fixed on the sleeved portion and spaced at an interval to each other, the other ends of the two bent portions slantly extended along opposite direction to each other and respectively connected with two ends of the jamming portion.

8. The earphone according to claim 1, wherein the bent portion has a radius of curvature, a middle portion of the bent portion fixed on the sleeved portion and outwardly bent to form two ends of the bent portion respectively connected with two ends of the jamming portion.

9. The earphone according to claim 1, wherein the fixed portion further comprises another one jamming portion, one end of the bent portion fixed on the sleeved portion and the other end of the bent portion connected with one ends of the two jamming portions.

10. The earphone according to claim 1, wherein the fixed portion further comprises another one bent portion, the jamming portion having a plurality of ratchets, one ends of the bent portions fixed on the sleeved portion and spaced at an interval to each other, the other ends of the two bent portions respectively connected with two ends of the jamming portion, the ratchets being continuous wave-like and disposed between the two bent portions.

11. An earphone with a fixed function comprising an earphone housing having a signal receiver with a speaker electric connected with the signal receiver, the earphone characterized in that: the earphone housing comprising a holding portion, a fixed portion extended from a periphery of the holding portion, the fixed portion having a bent portion and a jamming portion, one end of the bent portion fixed on the sleeved portion and the other end of the bent portion bent and extended to form the jamming portion.

12. The earphone according to claim 11, wherein the fixed portion further comprises another one bent portion, one ends of the bent portions fixed on the sleeved portion and parallelly spaced at an interval to each other, the other ends of the bent portions respectively connected with two ends of the jamming portion.

13. The earphone according to claim 11, wherein the fixed portion further comprises another one bent portion, each bent portion having a first arm and a second arm, one end of the first arm is fixed on the sleeved portion and outwardly and slantly extended to form the other end of the first arm, one end of the second arm connected with the other end of the first arm and inwardly and slantly extended to form the other end of the second arm respectively connected with two ends of jamming portion.

14. The earphone according to claim 11, wherein the fixed portion further comprises another one bent portion, one ends of bent portions converging at a point of the sleeved portion and extended radially from the point to form the other ends of bent portions respectively connected with two ends of jamming portion.

15. The earphone according to claim 11, wherein the fixed portion further comprises another one bent portion, one ends of bent portions fixed on the sleeved portion and spaced at an interval to each other, the other ends of the two bent portions slantly extended along opposite direction to each other and respectively connected with two ends of the jamming portion.

16. The earphone according to claim 11, wherein the bent portion has a radius of curvature, a middle portion of the bent portion fixed on the sleeved portion and outwardly bent to form two ends of the bent portion respectively connected with two ends of the jamming portion.

17. The earphone according to claim 11, wherein the fixed portion further comprises another one jamming portion, one end of the bent portion fixed on the sleeved portion and the other end of the bent portion connected with one ends of the two jamming portions.

18. The earphone according to claim 11, wherein the fixed portion further comprises another one bent portion, the jamming portion having a plurality of ratchets, one ends of the bent portions fixed on the sleeved portion and spaced at an interval to each other, the other ends of the two bent portions respectively connected with two ends of the jamming portion, the ratchets being continuous wave-like and disposed between the two bent portions.

19. An earplug with a fixed efunction comprising a sleeved portion and a fixed portion extended from a periphery of the sleeved portion, the fixed portion having a bent portion and a jamming portion, one end of the bent portion fixed on the sleeved portion and the other end of the bent portion bent and extended to form the jamming portion.

20. The earplug according to claim 19, wherein the earplug further comprises a sealed portion extended from a face of the sleeved portion and having a sealed space.

21. The earplug according to claim 20, wherein the earplug further comprises an abutting portion disposed with the sleeved portion.

22. The earplug according to claim 19, wherein the fixed portion further comprises another one bent portion, one ends of the bent portions fixed on the sleeved portion and parallelly spaced at an interval to each other, the other ends of the bent portions respectively connected with two ends of the jamming portion.

23. The earplug according to claim 19, wherein the fixed portion further comprises another one bent portion, each bent portion having a first arm and a second arm, one end of the first arm fixed on the sleeved portion and outwardly and slantly extended to form the other end of the first arm, one end of the second arm connected with the other end of the first arm and inwardly and slantly extended to form the other end of the second arm respectively connected with two ends of jamming portion.

24. The earplug according to claim 19, wherein the fixed portion further comprises another one bent portion, one ends of bent portions converging at a point of the sleeved portion and extended radially from the point to form the other ends of bent portions respectively connected with two ends of jamming portion.

25. The earplug according to claim 19, wherein the fixed portion further comprises another one bent portion, one ends of bent portions fixed on the sleeved portion and spaced at an interval to each other, the other ends of the two bent portions slantly extended along opposite direction to each other and respectively connected with two ends of the jamming portion.

26. The earplug according to claim 19, wherein the bent portion has a radius of curvature, a middle portion of the bent portion fixed on the sleeved portion and outwardly bent to form two ends of the bent portion respectively connected with two ends of the jamming portion.

27. The earplug according to claim 19, wherein the fixed portion further comprises another one jamming portion, one end of the bent portion fixed on the sleeved portion and the other end of the bent portion connected with one ends of the two jamming portions.

28. The earplug according to claim 19, wherein the fixed portion further comprises another one bent portion, the jamming portion having a plurality of ratchets, one ends of the bent portions fixed on the sleeved portion and spaced at an interval to each other, the other ends of the two bent portions respectively connected with two ends of the jamming portion, the ratchets being continuous wave-like and disposed between the two bent portions.
